(19) United States
(12) Patent Application Publication
(10) Pub. No.: US 2011/0188229 A1
(43) Pub. Date: Aug. 4, 2011

(54) ELECTRONIC DEVICE FOR RECEPTACLES, ACTIVATED BY REED SWITCH AND MAGNETO, OF HALL OR INCLINATION EFFECT, FOR EMISSION OF LUMINOUS AND/OR AUDITORY SIGNALS

(76) Inventor: Ramses Ulises Rizo Hernandez, Mexico D.F. (MX)

(21) Appl. No.: 13/063,586

(22) PCT Filed: Sep. 12, 2008
(86) PCT No.: PCT/MX2008/000127

§ 371 Date: Apr. 6, 2011

(51) Int. Cl. F21V 33/00; H05B 37/02; H01H 35/00

(52) U.S. Cl. 362/86; 315/360; 307/112

(57) ABSTRACT

An electronic device indicating the use of a receptacle containing different fluids such as receptacles for foods such as ketchup sauce, powder such as talcum or gel such as toothpaste or any product having this presentation. The receptacles are of the type comprising a top or a means to extract the product to be utilized. The electronic device is included in the receptacle independently of the size thereof and makes no contact with the product contained by the receptacle.

### FIELD OF THE INVENTION

The present invention relates to an electronic device for generating signals auditory or visual or both, when the receptacle or container including it is used or moved under certain conditions.

These devices are generally placed at the top of a receptacle or in any other part of the device for example in toothpaste, a receptacle of food products, etc. The recipient of the present invention can be activated by three different switches, not jointly.

### BACKGROUND OF THE INVENTION

For many years, it has been sought signaling the use of a particular product, so for example, Patent PA/a/2002009464 (equivalent to U.S. Pat. No. 6,557,728, paragraphs, and lines above are referred to this USA Patent). In general, it refers to a musical toothpaste tube cap. When the CAP is opened, and no matter the position of the switch, not being magnetic, mechanical or hall effect or tilting as the present invention after having opened the lid, it emits a signal light or sound, preferably music. Deactivation and activation of sound or light occur when the stud 29 plays and stops playing, respectively, the surface 34. It also indicates that it contains a switch, a signal generator, a timer and a battery. However, it does not indicate how these elements are interconnected and what elements are, nor indicates that they are coupled to a microcontroller (as it is the case of the present invention). It is limited only to specify that the elements are of common use, paragraph 2, lines 44 and 45. Elements used in the present invention are not as commonly used characteristics that must meet a first prerequisite which is being small in size, to be accommodated in receptacles relatively small, as well as other electrical and mechanical that will be described later. Neither it specifies how is that it manages to close and open the circuit, although the description shows that it is done by means of a mechanical system, the invention does not indicate the way in which it is achieved. It is worth mentioning that the electronic elements used for applications such as, require a special arrangement given the nature of the cap and with electrical, magnetic, and programming dimensions and values, etc., special due to the dimensions of recipients or products to which it will be applied.

Another example of a patent that refers to the field in question is U.S. Pat. No. 6,527,402 which refers to a perfume container with sound and light generator. According to that described therein, it includes means (10) to generate a sound or a light signal of a static or variable type over time. In the case of LEDs or sound electrically operated generator, energized electrically, see paragraph 1 line 62 to paragraph 9. The present invention is not intended, although it may be, to be placed in a case for the container, instead of this, the device of the present invention is intended to be to embedded or integrated, as appropriate, in the same receptacle. U.S. Pat. No. 6,527,402 refers to a container receptacle for perfume with means (10) which are to generate sound or light signals activated by a mechanical switch in the procedure described therein. Indicates for FIGS. 3 and 4 that such methods do not depend on the lid opening or the use of perfume, case similar to one of the conditions of the present invention. However, features of U.S. Pat. No. 6,527,402 refers to the activation can be done manually activating the switch (14), located on the outside of the casing. In the case of the present invention, the activation without the use of the product or opening of the lid is carried out by means of a ball or mercury switch, according to the case. This activation is done shaking or tilting the receptacle.

U.S. Pat. No. 6,527,402 specifies that if means (10) are activated by electricity, the invention includes a battery (not shown), which will be directly associated with such means. It also has a micro switch (14) or another member of control to activate means (10). However, it does not indicate or suggest what other means can be used, not it mentions the switches used in the present invention, such as for example, that of the hall-type effect, or cane or mercury or its possible implementation. Is not obvious to an expert regarding the inclusion of no mechanical switches such as that they should be selected so that can be included in a single electronic circuit so small that it can be included in casing and their performance to meet the needs of the invention of the electrical and mechanical ability to operate to the detect some movement brusque or shaking of the casing or the opening of the lid. U.S. Pat. No. 6,527,402 does not show or suggests the electrical components as they are mentioned in the present invention, neither its interrelationship with the battery nor the means of sound or light emission. Although it refers to an electrical circuit, it does not show nor suggests the interrelationship between and the different elements in the description or the figures.

From figures and description of this patent from U.S. Pat. No. 6,527,402, not specifying the use of specific switches described in the present invention or for the arrangement thereof suitable for different types of recipients or products, showing only one type of recipient or container only for a perfume and activated only mechanically, it is not designed for other types of recipients or containers, or suggests its application or variation for food products. Neither this patent specifies that sound or lighting sequences are controlled through a program designed specifically for this, as it is the case of the present invention. The invention of this patent requires the switch is directly touched for its activation. In the case of the present invention, switches are not touched, i.e., they are not activated by direct contact, but indirectly.

U.S. Pat. No. 7,147,014 is also known which refers to an intelligent device for filling of water; uses a pair of magnetic switches (423, 424), a battery (425) and a micro controller (422) mounted on a printed circuit board (421); This patent aims to indicate a high level and low level of water while the present invention does not refer to these applications or use switches of the kind referred to in the patent right, the layout and characteristics of the elements used in both inventions are completely different.

### BRIEF DESCRIPTION OF THE FIGURES

FIG. 1 schematically represents a switch of the Reed type, used in the present invention, the normally open-type.

FIG. 2 schematically represents the reed type switch normally closed, used in the present invention.

FIG. 3A shows the disassembly of the device application of the present invention.

FIG. 3B represents container or receptacle armed with set top and open cover as well as a detail of the interior of the cover with the cover closed.

FIG. 3c shows disassembly of another application on the device of the present invention, including a switch to allow for movement.

FIG. 4 is an embodiment which shows in detail the position of the printed circuit board of illumination and battery sources, for a pressure switch.

FIGS. 5A and 5B show another application which indicates that product exit tube passes through the printed circuit board and the possible position of the magnet which activates the switch reed.

FIG. 5C shows an example of the implementation of the hall-effect switch with a receptacle without lid.

FIG. 6 is a disassembly of the FIG. 3A embodiment, showing the device in disassembly for better understanding thereof.

FIG. 7 shows a block diagram of the device electronic circuit of the present invention.

FIG. 8 is the electronic diagram for lighting sequences.

FIG. 9 is a variant of the diagram of FIG. 8.

FIG. 10 corresponds to the electronic diagram for audio streams.

FIG. 11 is a variant of the diagram of FIG. 10 for audio streams.

FIG. 12 shows the dimensions used for the election of the Reed switch used in the present invention.

FIG. 13 shows the dimensions used for the election of the hall-effect switch used in the present invention.

FIG. 14 shows an example of a switch by shaking their positions to open A and closed B, referred as pellet (small lead bead).

FIG. 15 shows an example of the switch in maximum power save mode by a method of remote activation.

FIG. 16 shows a variant of FIG. 15 of the switch in maximum power save mode by a method of remote activation.

FIG. 17 represents the equivalent circuit to FIG. 10, but an application of the reed type switch normally open, connected in series with the battery and the micro controller.

FIG. 18 represents the equivalent circuit of the FIG. 11, but an application of the reed type switch normally open, connected in series with the battery and the micro controller.

### DETAILED DESCRIPTION OF THE INVENTION

The present invention will be described now using the figures attached hereto. It refers to an electronic device to provide luminous or acoustic signals at the time of use and/or movement of one part of the object such as a toothpaste tube, a shampoo bottle or container, a product as recipient for mayonnaise, ketchup, talcum powder, bath gel etc., or any other liquid products, powder or fluid gelatinous consistency. As noted, many applications alleged to the present invention relate to food products containers.

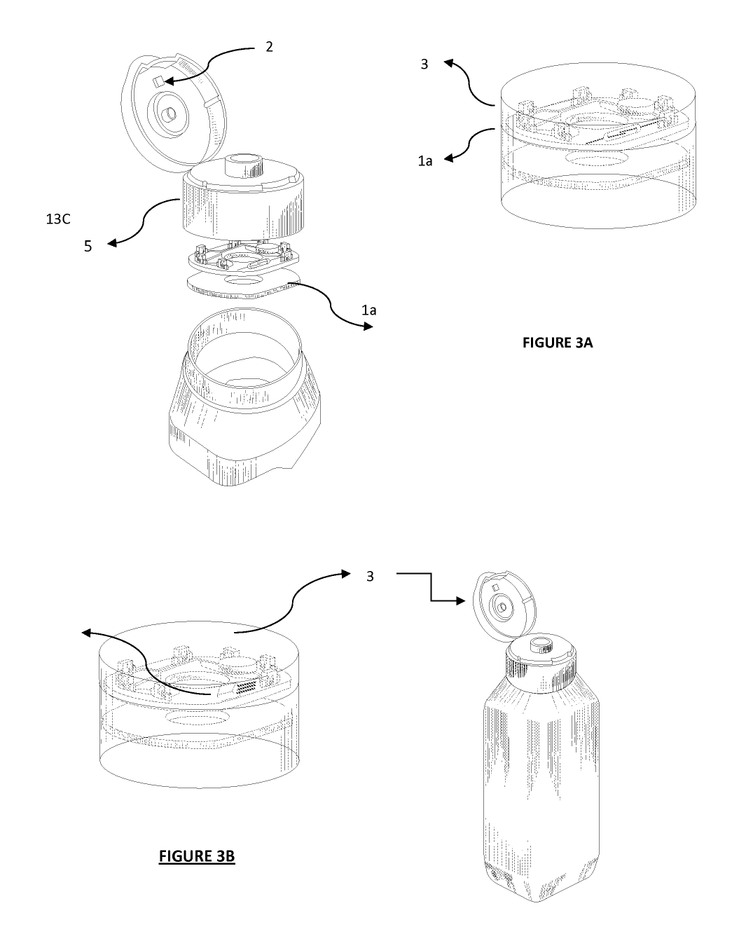

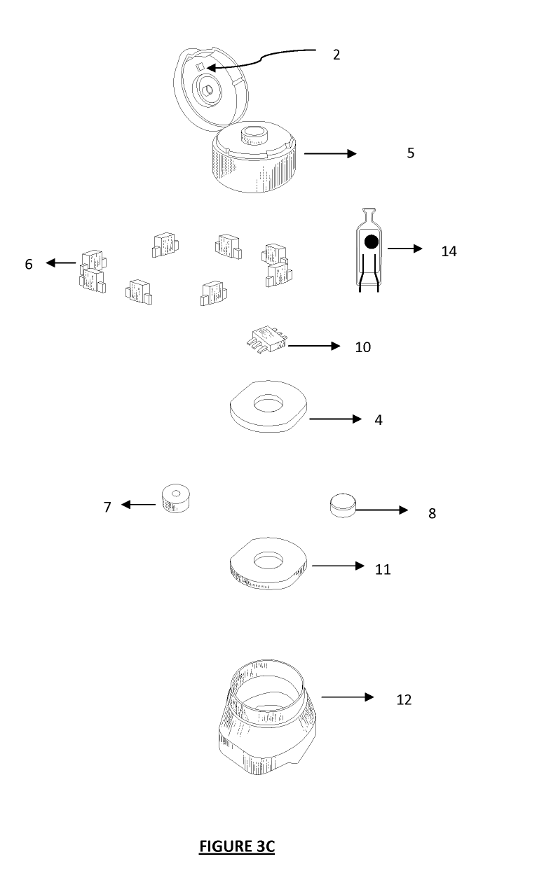

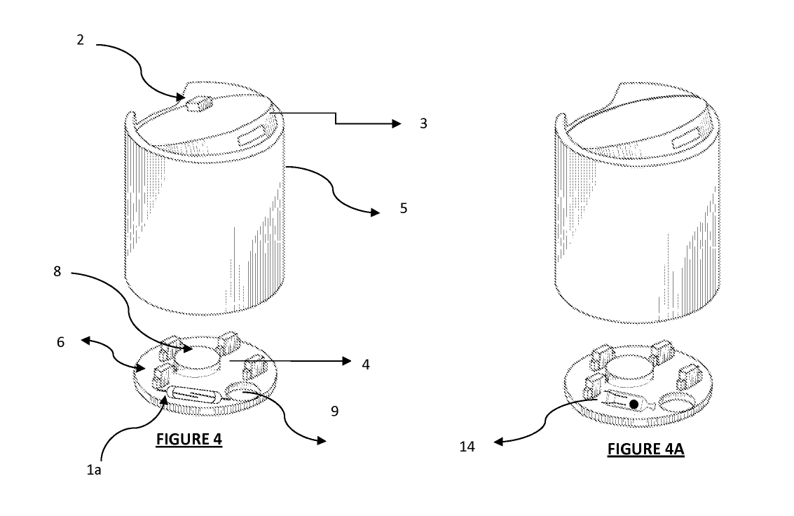

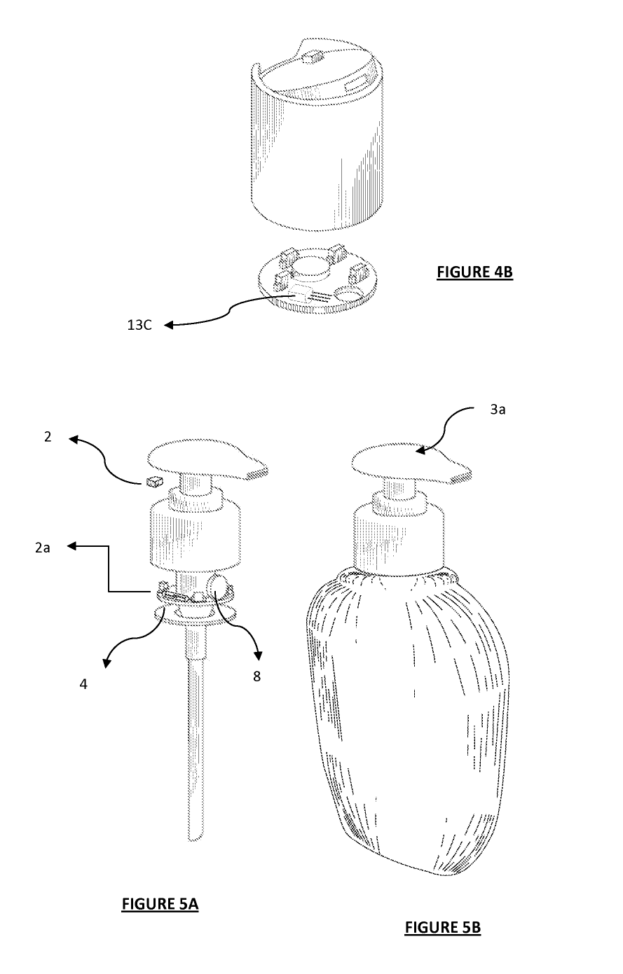

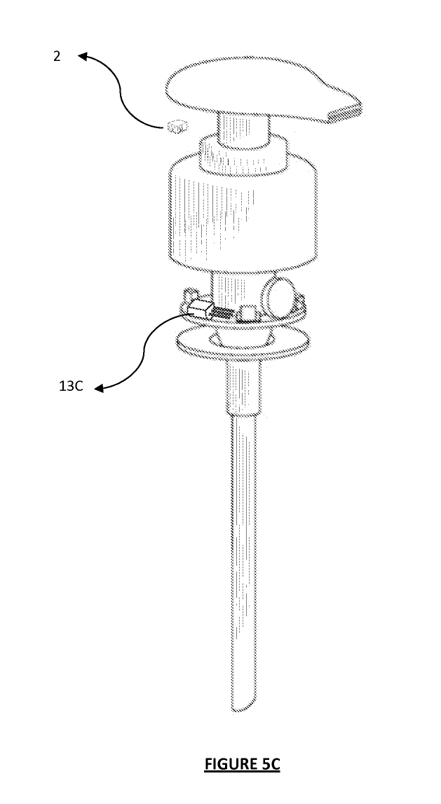

The object of the present invention is to provide an electronic device to provide luminous or acoustic signals and that may be adapted to a wide variety of receptacles. In general, the device emits lighting and/or auditory sequences each time that user opens the top cover of the supply means or receptacle is shake depending on the end use of the product. For example the opening of a lid cover or shaking an applicator as the one shown in FIGS. 3A, 3B and 3C. FIG. 4 is pressure-like as the one shown in FIGS. 5A and 5B.

Another object of the present invention is to provide a device which can be used safely in food receptacles with a minimum of risk for the user by contamination of the food product with electrical circuit components. This object is achieved by encapsulating electronic components and isolating them from the receptacle which is achieved due to the device configuration which does not require physical contact of the lid with the electrical circuit or the activation switch.

Briefly, the possible use of some of the switches, for example FIGS. 3A and 3B are used for cane switch (also called Reed) switch or hall effect sensor (13c), while FIG. 3C shows the switch for activation by shaking, which will be activated when the receptacle that contains is shaken or moved.

In the recipient of the FIG. 4, all switches with their respective adaptation may be used, recipients of the FIGS. 5a and 5b only will use hall effect sensor and the cane type since it corresponds to shampoo bottle and really is almost never tilted to use it.

The above makes clear that depending on the application it will be the type of switch to use: However, the device does not generally vary but its arrangement in the recipient and the type of switch to activate the electric circuit will vary.

An important feature of the electronic device object of the present invention is the fact that it does not require external elements to operate, i.e., it is a self-sufficient device. In the device there is the printed circuit card, batteries, control electronic means (chip or micro controller) and electrical signal management, control module, the means of reproduction of sound and/or lights and in all cases, except the case of the application of recipients with activation by lifting the lid, they are devices for activation of the electrical circuit.

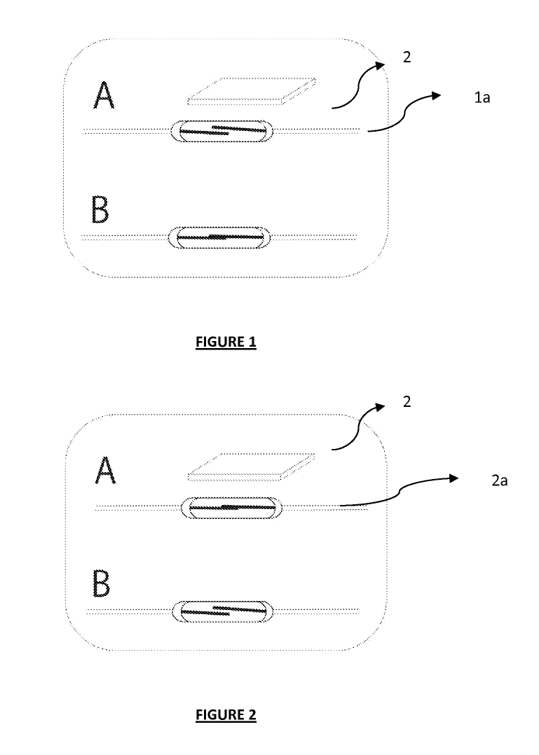

Back to FIG. 1, in the case of a reed switch (1a), normally open, the magnet (2), is placed so that when you open the cover (3), for example the cover of FIG. 3, or separated in some way the magnet (2) of the switch (1a), this switch will close the electronic circuit (4) (content for the printed circuit board) by starting the corresponding sequence of lights (6) or (7) sound, or both.

The position A of FIG. 1 represents the case of the switch (1a) normally closed, when the magnet is close to the switch (covered (3) closed the circuit and the switch are open and therefore the electronic circuit (4) is inactive.) Position B of FIG. 1, indicates the position in which the switch (1a) is closed by the effect of separating the magnet (2) of the Reed switch (1a) ((3) open cover) allowing the activation of the elements (6, 7) (see FIG. 3B).

A similar approach applies to the case of FIG. 2, where is a normally open switch (2a). This will be used if the application requires so; These two examples only as examples and not limiting cases of the invention should be considered, sometimes it will be necessary to work systems in reverse, i.e., that activates the switch when it closes and is turn off when the lid is opened. 0 in the same way will require the installation of such a switch of the type shown in FIG. 3C.

In the case of the switch Reed (1a, 2a) and the hall effect sensor all elements are contained within the tablet of the printed circuit board (4), except the magnet (2) that is located at the top of the receptacle. The rest of embodiments include all the components needed for its operation mounted in the same tablet of the printed circuit board. It is why the tablets can be placed in a variety of receptacles, almost regardless of its shape and form of use.

An application for the case of the switch (2a), shown in FIG. 2, note FIGS. 5A and 5B.

In this description, unless specifically indicated the type of switch normally closed or normally open, the term reed switch refers to either of these two types depending on the application, as it will be obvious to a person skilled in the art. For energy saving purposes, the normally closed reed switch will be preferable, which is not a commercial switch and built for exclusive application in the present invention.

Also, as it will be obvious to a person skilled in the art, the various values involved in the selection and placement of this type of switches is not a matter of simple trial and error. To achieve the correct position and values of characteristics of the Reed switch and magnet power, carried out various investigations, calculations and statistics.

In FIG. 4, it may be appreciated that the circuit or Tablet (4) carries the battery (8) and also has a bore (9), which serves to let the product pass through the vessel towards the exit for the supply thereof, this is a special feature of the device of the present invention. This non contact feature of the food product with the device is to avoid a possible food poisoning, due to the electronic components of the device. As may be seen in FIGS. 3A and 5A, the bore (9) can change location depending on the use for the device, and does not have this bore (9), or even take the form of a half moon or any other if required by the application.

The circuit (4) can be embedded in the material which forms the lid (5) FIG. 4 or any receptacle, can set in a removable manner so that it is used again in a new receptacle or can be set not removable way through for example a glue.

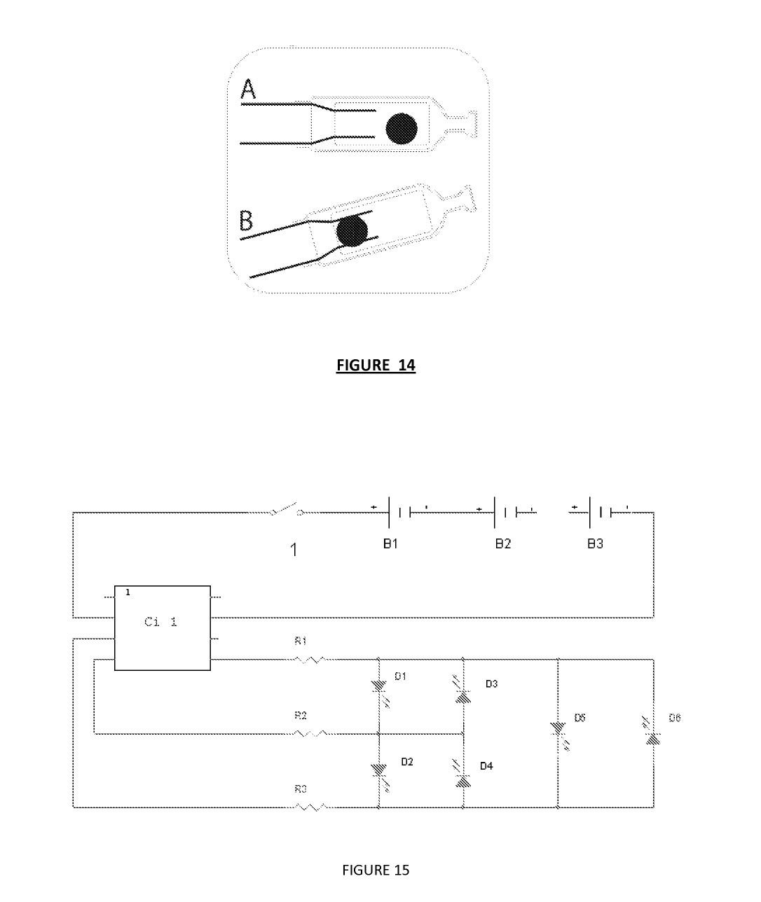

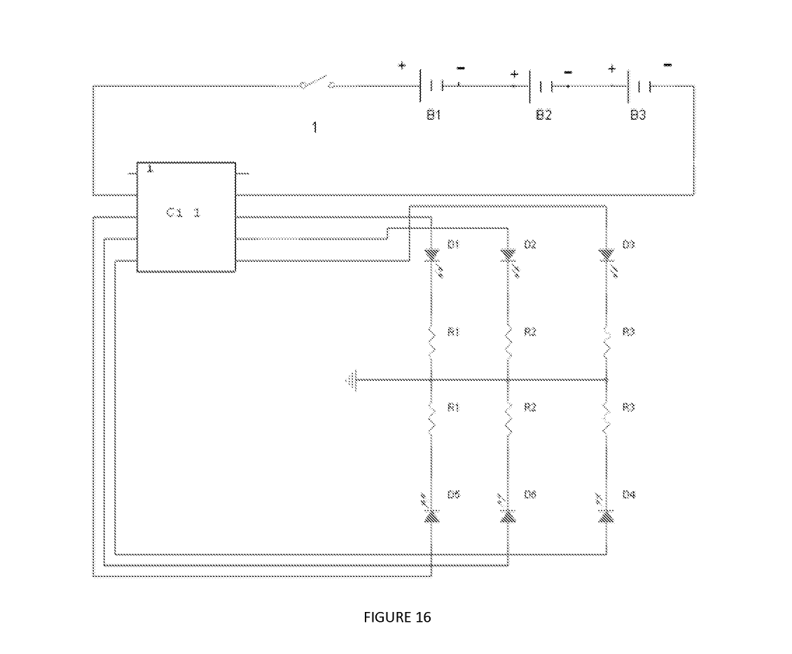

The batteries may comprise or not at least one (not shown) plastic strip which electrically insulated stacks of the electrical circuit (4) thus saving energy and increasing the useful life of the device (1) of the present invention. As alternate embodiment, in the case of cane-type switches, two alternating circuits represented by FIGS. 15 and 16 were designed. These circuits have the characteristic that does not consume energy but until that begins the work of the device. These circuits replace the use of the plastic strip. In this case, we could stop using the Strip plastic if Reed switch is connected to the positive battery pole so later, this switch can take action of the energizing of the system only to leave the lid closed, therefore the system does not consume anything of battery power as shown in the new FIG. 15 and its variant FIG. 16.

These two diagrams work same way except that they do not consume electric power because Reed switch regardless of whether it is a normally open or normally closed as shown in the diagrams.

For better understanding of the invention a case is described in which there is the product of the FIGS. 3A, 3B and a cane switch as the one of FIG. 2A used. At this point, when the lid is closed, it will be never consuming electric power. It will only consume electric power at the time of opening the lid and after 5 minutes it will enter into standby mode if the lid is left open, but there would be no problem because in this way, it consumes a minimum of energy being the minimum on the order of a few peak amps.

Obviously this is a great advantage because the product shelf life is increased by logic, besides after the purchase, if somebody plans not using the product, it simply closes and is kept stored, the life of the device depends only of the quality of used batteries. Years may be spent without running out of batteries and thus the device of the present invention keeps under operation. Logically the batteries are discharged naturally or by effect of the environment, but as long as batteries, to operate the user retains the usefulness of the device when it decides to use it.

For manufacturing processes this would be a highly efficient aid, as they come to take months already finished products in a cellar and with this system will resolve this discomfort for manufacturing processes.

It is therefore a great technical advantage that just changing the switch to another position, radical changes may be achieved, and therefore the system becomes more robust and better performance with these technical additions.

This system is ideal for the cane switch even it is also useful for Hall effect switch, not for the motion sensor, the latter must use the plastic strip, since when it is in motion, for example, from the factory to the store, the system starts energy consumption, reducing considerably the useful time of the batteries.

The product with the switches described above does not consume energy but only until the very moment that the user opens the lid, this is a great technical advantage to achieve batteries energy saving.

When the switches are not of the Reed or cane type or Hall effect type, plastic strip is used. Such strip can be returned to its position, when you know that the receptacle will not be used until a true long time later. As a complement of this method of energy saving, the micro controller (10) includes in its programming a series of steps in which detects the time during which the product has been left. If it has been more than 5 minutes, the system enters on standby mode. It will always be in standby mode and in this state, it would have a consumption of about the micro amps and so tiny quantities can currently be achieved as the peak amps in standby mode, which means that it may be years with relatively unused batteries. Logically that the batteries are not downloaded by the effect of the environment.

To better describe the invention, the embodiment described in FIGS. 3A and 3B will be considered, this is, an electronic device activated by a reed switch of the normally closed type. When the cover above (3) is closed, the magnet (2) is the distance nearest switch Reed (1a), by which it detects the magnetic field produced by the magnet, then the Reed switch is in its open state (FIG. 1, position B). The circuit considered this as the standby or shutdown state.

When the opening of the cover (3) of the lid (5) occurs, (see FIGS. 3A, 3B and 4) magnet (2) is the most distant of the Reed switch distance (1a), by which it does not detect the magnetic field produced by the magnet then the Reed switch changes to normal or closed state and the circuit considers this state as the beginning of operation to display a light or auditory sequence for a predetermined time.

In an embodiment of the paragraph above of FIG. 4, it works in opposite way, i.e., when there is the opening of the cover of FIG. 4, the magnet is the nearest to the Reed switch distance by which it detects the magnetic field produced by the magnet, then the Reed switch switches to its normal or open state and the circuit considers this state as the beginning of operation to display a light or auditory sequence for a predetermined time.

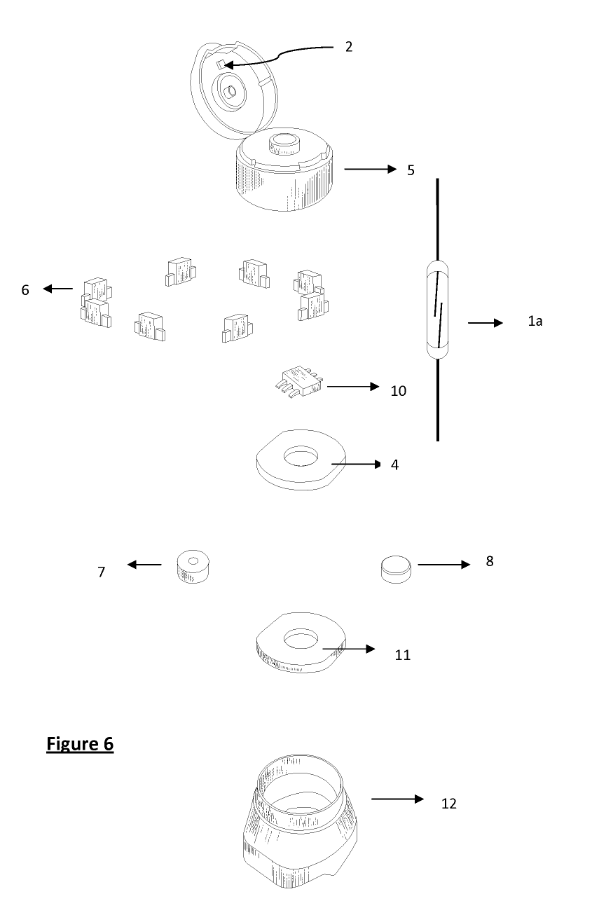

After a predetermined time, the timer included in chip (10), FIG. 6, it will lead to the electronic system to inactivity regardless of whether the switch (1a) is open or closed is to say if the cover is closed or open 3, and the chip 10 will be “pending” when the user makes again the opening or closing of the cover 3. Packer 11 which is optional, is used to isolate the plaque 4 of contents of the receptacle 12.

The default time of operation of the elements (6, 7) is set at factory through a program included in the chip or micro controller (10).

An alternate embodiment of the operation of the switch (1a) is represented in FIGS. 4, 5A and 5B. When the applicator (3a) of the FIGS. 5A, 5B is in the position of non-use (above), the magnet is the distance farthest from the reed switch (2a), for what it does not detect the magnetic field produced by the Magnet, leaving the reed switch (2a) in its not normal or open state (FIG. 2, position A). The chip (10) considers this state of standby or shutdown.

When the downward movement of the applicator (3a), the magnet is close to the Reed switch and then it changes the state of the switch to its normal state or lock and closes the electronic circuit, starting a sequence of lights and/or sound during a predetermined time.

After the predetermined time, chip (10), take the circuit to inactivity regardless of whether or not in operation position of the applicator (3a).

FIG. 6 illustrates the arrangement of the various components through an exploded view and that is equivalent to the exemplary form of FIGS. 3A and 3B.

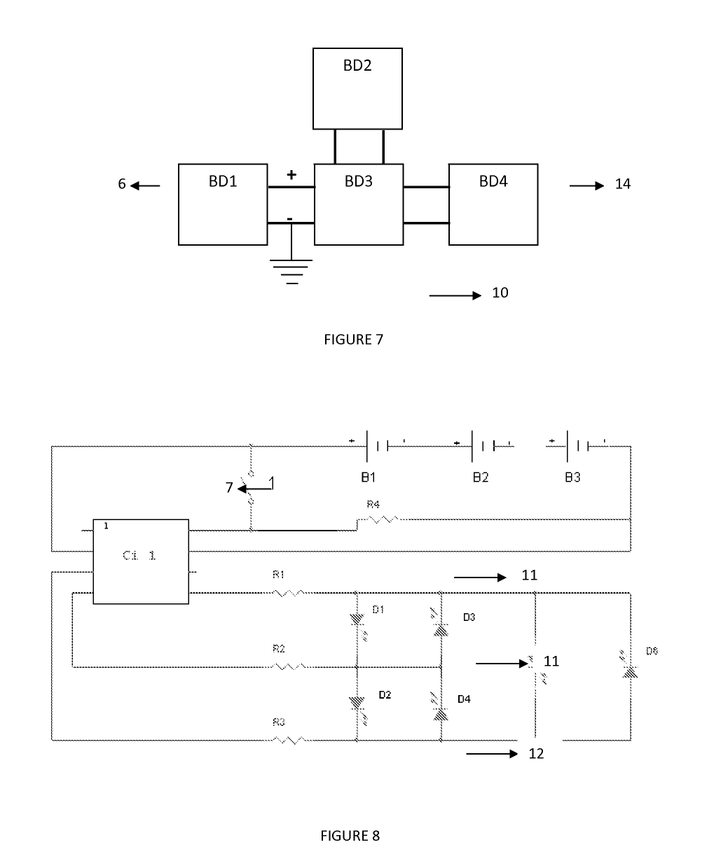

FIG. 7 shows the block diagrams of electronic circuit mounted on the printed circuit board (4), of the device of the present invention.

The electronic system comprises four blocks, the first of these BD1, is the energy supply system and comprises energizing means represented by a set of batteries or batteries that allow the energizing of the system and the control of the lighting and/or auditory sequences.

BD2 represents an activation system that includes the Reed switch (1a or 2a) or the HALL effect sensor to the magnet or magnet (2) and the shaking sensor that indicates the inputs and outputs BD3 control system the beginning of a light or auditory sequence.

BD3 represents the inputs and outputs control system and comprises the set of integrated circuits (IC), or micro controller, represented by the chip (10), (see FIG. 6) used to detect the changes from the system's activation, then activates the system of lighting and/or audio BD4.

It is important to highlight that switch (1a) has been chosen to clearly describe for a person with average knowledge in the material of the device object of the present invention. However, other types of switch, such as Hall effect switch, small lead pellet switch, mercury switch, may be used.

The lighting and/or audio BD4 system comprises one or more selected audio elements, such as spotlights, light-emitting diodes light, bulbs or alike, whether buzzers, horns or anything else to produce sound or audio waves.

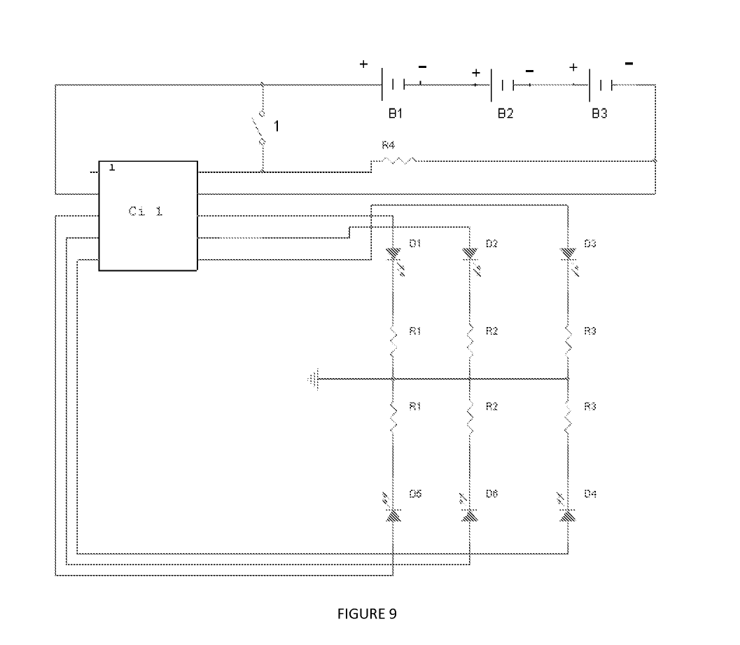

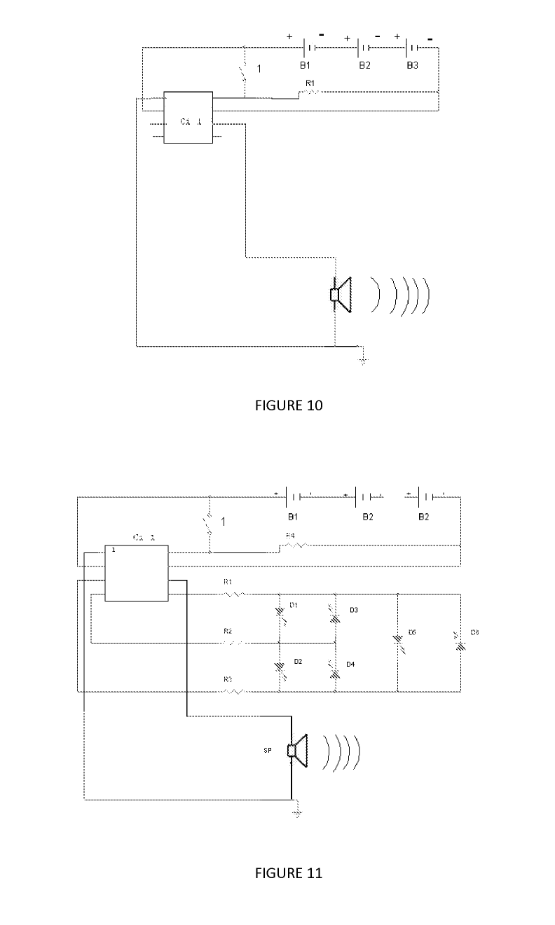

FIGS. 8 to 11 show the different variants of electronics of light signals generating circuits (FIGS. 8 and 9), auditory (FIG. 10) and both signals (FIG. 11).

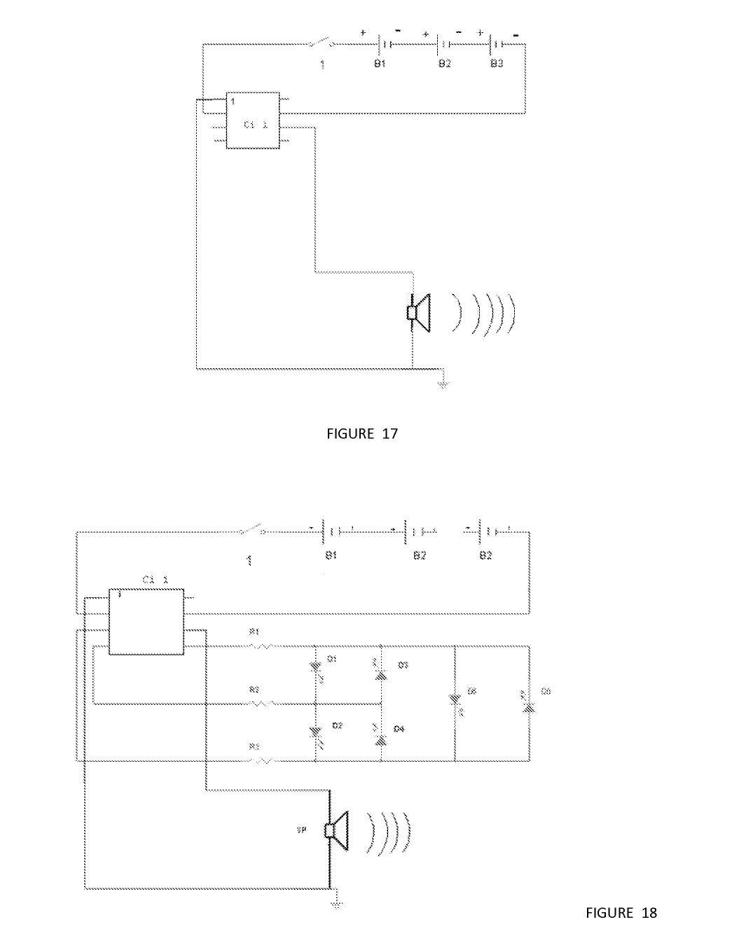

FIGS. 15, 16, 17 and 18 are the support for the concept of energy saving to zero during non-use of the device.

In the previous figures, the element (10) represents a micro controller or chip with an integrated program to carry out the different stages of the electronic device.

The micro controller program is designed to work exactly as shown in the block diagram BD1 to BD4. Starts with the setting of entry and exit pins to put them as necessary, either as inputs or outputs, then on its next execution, it will verify if entry into where the switch is, has the same in this case open or closed detects a logical 1 or zero depending on the switch type. Whether the cane or Reed switch or sensor shaking switch (also called movement) or hall effect sensor seeks a predetermined voltage to activate some internal sequence in the micro controller, than can be a shot of a logical 1 or a logical zero, then sending to activate the lighting and audio BD4 stage, depending on the result at that pin is what the chip or micro controller run.

One of the states is being dormant or in standby mode and the other is to order ignition of audio or lighting block, or both to later switch to standby mode after a predetermined time in the program developed and be waiting that a change in this pin happens to either wake up or send to execute some routine.

### Reed Switch Choice

As mentioned, the Reed switch has been selected based on different parameters. Following research for the selection of the appropriate magnet 2 was performed to create the activation of lighting and/or auditory sequences.

TABLE 1

| | | | | Maximum | | | |
|---|---|---|---|---|---|---|---|
| | | | | product | | | |
| | | | | of energy | Length | Reed switch | |
| | Magnet | | | (BH) | of Reed | Distance | Distance from right |
| Magnet | construction | Measure | | (BH) max | switch | Sensitivity | horizontal |
| Number | material | mm | Degree | (MGOe) | (L) mm | (Y:) mm | displacement (X:) mm |
| 1 | NdFeB | 10 * 10 * 1.5 | N35 | 33 to 36 | 5 | 5 | 0.0 |
| | | | | | | 15 | >=5 and <=15 |
| | | | | | 14 | 3 | 0.0 |
| | | | | | | 10 | >=5 and <=15 |
| 2 | NdFeB | 10 * 10 * 1.5 | N38 | 36 to 39 | 5 | 7 | 0.0 |
| | | | | | | 20 | >=5 and <=15 |
| | | | | | 14 | 3 | 0.0 |
| | | | | | | 13 | >=5 and <=15 |
| 3 | NdFeB | 10 * 10 * 1.5 | N35 | 33 to 36 | 5 | 5 | 0.0 |
| | | | | | | 15 | >=5 and <=15 |
| | | | | | 14 | 3 | 0.0 |
| | | | | | | 10 | >=5 and <=15 |

### Conclusion and Magnet Choice

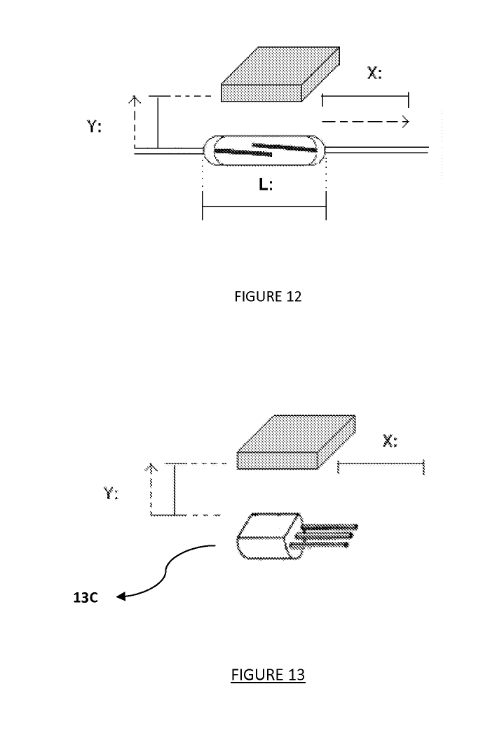

For this conclusion, we will support in FIG. 12, in which (Y) represents the distance of sensitivity of the Reed switch, (X) the right horizontal scrolling and (L) distance is the length of the Reed switch, the rectangle representing the bar magnet or simply magnet.

By means of statistical analysis that was carried out with different Reed switches and magnet bars with different grades and measures, was that a bar of 10 mm*5 mm*1.5 mm is adequate for the implementation of the electronic system in any of the different products such as mayonnaise, ketchup, shampoos, toothpaste, bath gel, powders, and some other receptacles. It is important to point out that the measures of the receptacles are not relevant to the operation of the device object of this invention. Nor is the size of the cover, this device works equally well for receptacles of small to large size receptacles.

From commercial switches can be concluded that the reed switch size 5 mm or even the size needed for the application can be placed with a range from 5 mm to 15 mm for the distance “Y” and from 5 mm to 15 mm for distance reaching its maximum effectiveness when the distance “Y” is equal to 15 mm and the distance “X” is 15 mm, see FIG. 12.

It is important to clarify that the distances between magnet and Reed switch are independent of the size of the cap, by which the activation system can be applied from a very small cap up to a cap very large.
Magnetically Activated Reed switch can work in a range of temperatures ranging from −55° C. to 125° C.
Reed switch supports a power of 5 watts, but only consumes 27 mW UP TO 45 mW, which accounts for up to a thousand percent (1000%) more than security to avoid damage to the switch by effects of the power of the electronic system. Doing, in the most efficient Reed switch and allowing to lengthen their life time.
The Reed switch has a life expectancy of 10⁸ switches, reducing the probability of switch failure.

So far has been described as the most informative form of the present invention. However, it is not the only one and below mentioned alternate modes.

As it can be seen from FIGS. 8 to 11 and from the description above, the present invention could use three different types of switches to operate with different recipients. Each switch has its own application but some of them can be swapped. For example in receptacles like the one shown in the FIGS. 3A, 3B, 3c and 5A, 5B.

Three switches are: Reed switch, hall switch and that of shaking or movement effect. At the same time, the motion sensor can be one of mercury or pellets, all of them are described below.

### Hall Type Switch Selection

Regarding the Hall type switch, also a series of measurements and statistical calculations based on contained in TABLE 2, to determine the best switch dimensions to be used.

TABLE 2

| | | | | Maximum | | | |
|---|---|---|---|---|---|---|---|
| | | | | product | | | |
| | | | | of | Sensitivity | Distance | |
| | Construction | | | energy | IGNITION/ | Sensitivity | Distance from |
| | of the | | | (BH) | SHUTDOWN of | of Reed | right horizontal |
| Magnet | magnet | Measures | | (BH) max | Hall effect | switch (Y:) | displacement (X:) |
| Number | material | mm | Degree | (MGOe) | switch. (S) | mm | mm |
| 1 | NdFeB | 10 * 10 * 1.5 | N35 | 33 to 36 | SHUTDOWN yes | 1 | 0.0 |
| | | | | | <=(250 Goe) | 15 | >=1.0 and <=10 |
| | | | | | IGNITION yes | | |
| | | | | | >=(250 GOe) | | |
| 2 | NdFeB | 10 * 10 * 1.5 | N38 | 36 to 39 | SHUTDOWN yes | 1 | 0.0 |
| | | | | | <=(250 Goe) | 20 | >=1.0 and <=15 |
| | | | | | IGNITION yes | | |
| | | | | | >=(250 GOe) | | |

### Conclusion in the Selection

For this conclusion, FIG. 13 shows the steps involved, S represents the sensitivity of ignition and shutdown of the Hall, X the distance of right horizontal scrolling effect switch and Y is the distance of sensitivity of Hall effect switch the rectangle represents again the bar magnet or simply magnet.

By means of statistical analysis that was carried out with different switches type of Hall effect and magnet bars with different grades and steps, was obtained that a 10 mm*5 mm*1.5 mm is adequate for the implementation of the electronic system in any of the different products such as common receptacles for mayonnaise, ketchup, shampoo, toothpaste, bath gel, powders and some other receptacles; that meets the needs of distance and ranges of activation “Y”, “X” described in TABLE 2.

For what it is concluded that a hall-effect switch with sensitivity of 250 GOe shutdown can be placed with a range that varies from 1 mm to 15 mm in the distance Y, and from 1 mm to 15 mm in the distance X, reaching its maximum effectiveness when the distance Y is equal to 15 mm and the distance X is 10 mm (see FIG. 13).

On the other hand, a hall-effect switch with 250 GOe ignition sensitivity can be placed with a range of 1 mm to 15 mm at the distance Y, and from 1 mm to 10 mm at a distance X; reaching its maximum effectiveness when the distance in Y is 15 mm and the distance X is 10 mm.

It is important to clarify that the distances between magneto and Hall effect switch are independent of the size of the cap, by which the activation system can be applied from a very small cap up to a cap very large.

The Hall effect switch can work in a range of temperatures ranging from −65° C. to 150° C. as a switch of solid-state Hall effect switch has a virtually unlimited number of switches. Of course, that under conditions of operation within practical limits of use of the products to which this new device is intended.

### Selection of the Switch by Movement

With reference to FIG. 14 in the position to the switch is open, in the B position obviously the circuit is closed to join contacts through the small lead pellet or mercury. The selection of this switch is apparently trivial. However, this must be considered technical aspects such as: desired angle of the circuit activation, switch driving ability, dimensions, the same and easy use of the user for his convenience for example for a receptacle or ketchup bottle that will activate the system by a predetermined amount of time it at the time of hold it for use, and also does not have any component that can be intoxicated by the user because all go hidden under plastic packaging. It is necessary to select an angle and force of agitation for the activation of the circuit because such a poor selection leads to an activation by any movement or failing even without movement, therefore should be his inclination and this was 15 degrees, for example during cleaning of the support of the recipient or shift it to change its position.

This type of device (tilt switch) will have a plastic mica which will remove the user so that thereafter the batteries begin to work for the first time and this is done just in time before the use for the first time of the product. Please take note that there is the mode in which this mica or plastic strip is not used.

For the purposes of description it should be understood that the shaking switch is the same than the tilt switch and the switch of movement, this type of device preferably has a plastic mica to turn off the battery, this is so if it is transported on a ship, the movement of the ship or transport means would be moving and picking up many times during the journey to your destination and therefore it would consume batteries before reaching land. This does not happen with the Reed switch, for example see FIGS. 15 to 18.

Obviously such a tilt switch can also be applied to systems where using the switches reed or hall effect. However, activation will be by agitation or movement.

Introduce a switch activated by shaking or agitation must comply with certain requirements that are not activated by the mere movement of transfer of the receptacle from one place to another or from a blow to the furniture on which is the receptacle.

When there is the inclination or agitation of the product then the mercury switch or lead pellet changes its status to closed or bound together for some time in the inclination or agitation of the product and the chip consider this state as the beginning to show a new sequence light and/or auditory for a predetermined time. This same effect occurs with the rest of the switches.

After the predetermined time, the micro controller (10) will be the electronic system to inactivity regardless of whether or not is tilted, but not if person is shaking the product, that thus begin another sequence, and so the chip will finish its process when it is at rest or without motion receptacle.

The diagrams shown in FIGS. 8 and 9 are different in terms of some of its constituents but develop the same work.

Some of the advantages of electronic diagrams here described are:
Low voltage level of activation of each of the light emitting diodes and/or elements of audio, which ranges from 2 volts up to 4.5 volts.

Low level of power consumption of the set of light emitting diodes and/or elements of audio, including from the 6 mA up to 10 mA. As a result the circuit has a low maximum power consumption ranging from 27 mW to the 45 mW. When in use, but if it is in standby mode its current will be fluctuating in the order of peak amps which means that its consumption is virtually null. The circuit represented by 15 to 18 figures are, equivalent to the circuits of the FIGS. 8 to 11, with zero power consumption when the device is not in use. The particularity of the circuits of the FIGS. 15 to 18 is that the switch that is exclusively used is cane.

With the use of only three terminals or ports of the micro controller or chip they are manipulating six light emitting diodes, when they should normally be used 6 terminals or ports of the micro controller. This is in order to make savings in the costs of the micro controller, already that if you have more terminals or pins, the cost is higher and the user will see it affected, why are these innovative advantages developed exclusively for this patent.

Use of surface mount (also known as SMD LED) light emitting diodes which allows to make a remarkable saving of space with respect to the conventional light emitting diodes.

The micro controller leads to the electronic system by way of “sleeping or waiting”, which helps conserve the use of energy in the batteries for months. With regular use of the user of batteries typically have the ability to last a minimum of 3 months.

The size of the batteries is small (7.5 mm by thickness of 3.5 mm diameter). Ideal for placing in small spaces. The system uses a maximum of three batteries 1.5 volts. But they could change the size and number depending on the application.

The light-emitting diodes have a time of life of 100,000 hours, ensuring the user the emission of light for the normal duration of the battery.

The use of light-emitting diodes of high brightness, which allows a maximum of brightness with a minimum of energy.

Use of elements of audio of high gain and efficiency, which allows to emit sound waves over long distances, with the use of a minimum of energy.

Due to the management of level low voltage (4.5 volts maximum) is to have maximum user safety and reduces the likelihood of electric arcs to zero. Totally secure electronic system and reliable use given the moist environment in which will operate, such as bathrooms, showers, kitchen, etc.

The electronic system used here is a dedicated and customized for receptacles of trade such as those used for sauce products ketchup, shampoos, toothpaste, Bath gels, powders, deodorants and some other receptacles with lid of the bascule type screws, pressure, etc. An innovative device activation not spoken used before system is used in this type of receptacles. The fact that it is not in this type of packaging is due to the size of the device, the configuration of the same, the way to achieve that the luminous and acoustic means activate is not a simple to solve problem in fact it is not the solution to a single technical problem but a number of technical details that were saved for this device, which also has the particularity of to exchange their way of activation using an electronic circuit with some variants that are detailed in this description and in the Exhibited drawings.

Another inventive part lies in that the user does not have access to the electronic system in any way and that is to not intoxicate to the product or to the user.

Respectfully expressed that the present invention is not obvious to a person skilled in the art because it is not obvious that this kind of electronic devices, for these applications, activate without touching the switch, i.e. activate distance. There are no cables or mechanical elements that touch switches to activate the new electronic device. It must take into account the size of the systems described here and its inclusion in the state of the art vessels, receptacles do not need to be substantially modified to include any of these devices, nor is there the risk of contamination by including electronic components since it isolate of the product containing the receptacle that includes the new device electronic.

It is also a special feature of the present invention that a receptacle can be activated through three different devices of activation of the electronic circuit without substantially altering the electronics. This exchange of switches will definitely depend on the use that is intended to.

In general, the system has three operational stages:

STAGE 1: waiting for activation of the switch;

STAGE 2: beginning of the cycle of light and/or sound for a preset time.

STAGE 3: standby for activation of the switch with minimum or zero energy consumption.

The state of the art devices are activated in a mechanical way, where the switch is activated directly touching the same. The present invention provides a device with an extremely low power consumption or with a zero power consumption when not in use.

The micro controller is controlled by a program, which performs the operations:

(a) waiting for activation by the switch, close the electronic circuit, activating the means light and/or sound emitting according to the configured schedule of factory;

(b) maintain the activation of the means during a predetermined time;

(c) initiate standby mode of activation of the switch with minimum or zero energy consumption.

1. An electronic device for receptacles, to emit lighting and/or acoustic sequences when used, comprising means for lighting, means to generate sound, energizing means, wherein it comprises auto contained activation means in the electronic device within an electronic circuit.

2. The device according to claim 1, wherein the electronic circuit is a circuit board for being assembled on a surface which comprises also a micro controller, controlled by a program, which performs the operations of:
a) waiting for an activation by the switch, close the electronic circuit, activating the light and/or sound emitting means according to the factory configuration;
b) maintain means activation during a predetermined time;
c) initiate switch activation standby mode with minimum or zero energy consumption.

3. The device according to claim 2, wherein the device is included in a receptacle to contain a fluid, where the fluid is selected from the group of liquid products, gels and powders.

4. The device according to claim 3, wherein activation means are chosen from the group comprising a movement-activated switch and magnet-activated switch.

5. The device according to claim 4, wherein the magnet-activated switch is chosen from the group consisting of Reed switch or Hall effect switch and where the magnet is placed in a part of the receptacle in which the magnet approaching or moves away from the switch depending on whether it starts or the use of the receptacle is over.

6. The device according to claim 5, wherein the switch is placed in series with the energizing means and the micro controller.

7. The device according to claim 6, wherein the switch used is normally open reed-type.

8. The device according to claim 4, wherein the switch is a switch activated by movement.

9. The device according to claim 8, wherein the switch is placed in parallel with the energizing means and the micro controller.

10. The device according to claim 9, wherein the switch is selected from the group comprising a switch type small lead bead and mercury type.

11. The device according to claim 7, wherein the switch is placed in parallel with the energizing means and the micro controller.

12. The device according to claim 4, wherein the micro controller controls the time and order of the light and auditory emission.

13. The device according to claim 12, wherein it has no contact with the product that contains the recipient.

14. The device according to claim 13, wherein the device is placed in receptacles of different sizes without altering their functioning.
